(19) United States
(12) Patent Application Publication
(10) Pub. No.: US 2026/0327983 A1
(43) Pub. Date: Oct. 22, 2026

(54) EMBOSSED ROOFING MEMBRANE AND SHINGLE, AND ASSOCIATED ROOFING SYSTEM

(71) Applicant: BMIC LLC, Dallas, TX (US)

(72) Inventors: Gurpreet Sandhar, Langley City (CA); Sahar Khedri, Langley City (CA); Janany Kugathasan, Langley City (CA)

(21) Appl. No.: 19/122,120

(22) PCT Filed: Oct. 24, 2023
(86) PCT No.: PCT/IB2023/000647

§ 371 Date: Apr. 17, 2025

Related U.S. Application Data
(60) Provisional application No. 63/382,184, filed on Nov. 3, 2022.

(51) Int. Cl. E04D 1/20; B32B 3/30; B32B 5/02; B32B 7/12; B32B 27/12; B32B 27/32; E04D 1/30; E04D 1/34; H02S 20/25

(52) U.S. Cl. CPC E04D 1/20; B32B 3/30; B32B 5/028; B32B 7/12; B32B 27/12; B32B 27/32; E04D 1/30; E04D 1/34; H02S 20/25; B32B 2262/101; B32B 2307/3065; B32B 2419/06; B32B 2457/12; E04D 2001/308; E04D 2001/3423; E04D 2001/3435; E04D 2001/3491

(57) ABSTRACT

An embossed roofing shingle, including: a first layer; and a second layer under the first layer, wherein the first layer comprises an embossed surface, wherein the first layer comprises a thermoplastic polyolefin, and wherein the first layer is configured to be exposed to the environment when the embossed roofing shingle is located on a roof deck.

### CROSS-REFERENCE TO RELATED APPLICATION

This application claims the benefit of priority to pending U.S. provisional patent application 63/382,184, titled “EMBOSSED ROOFING MEMBRANE AND ASSOCIATED ROOFING SYSTEM,” filed Nov. 3, 2022, the disclosure of which is incorporated by reference herein in its entirety.

### FIELD

The present invention relates to a roof covering, and, more particularly, relates to a roofing shingle, a roofing membrane, and associated roofing systems.

### BACKGROUND

A roofing system often includes standard asphalt shingles installed on a roof deck. In a solar roofing system, standard asphalt shingles may be installed adjacent photovoltaic shingles. However, there is often a visual disparity between the asphalt shingles and the photovoltaic shingles installed on the same roof deck, such that the solar roofing system including both shingles is not aesthetically pleasing.

### SUMMARY OF THE INVENTION

The Claims, rather than the Summary, define covered embodiments of the present invention. The Summary is a high-level overview of various aspects of the invention, and introduces some of the concepts that are further described in the Detailed Description below. The Summary is not intended to identify key or essential features of the claimed subject matter, and also is not intended to be used in isolation to determine the scope of the claimed subject matter. The subject matter should be understood by reference to appropriate portions of the entire Specification, any or all drawings, and each claim.

In some embodiments, the present invention provides an embossed roofing shingle, comprising: a first layer; and a second layer under the first layer, wherein the first layer comprises an embossed surface, wherein the first layer comprises a thermoplastic polyolefin, and wherein the first layer is configured to be exposed to the environment when the embossed roofing shingle is located on a roof deck.

In some embodiments, the second layer comprises an adhesive.

In some embodiments, the second layer comprises a butyl adhesive.

In some embodiments, the second layer is configured to adhere the embossed roofing shingle to the roof deck.

In some embodiments, the embossed roofing shingle further comprises a removable release liner under the second layer, wherein the removable release liner is configured to be removed to expose the second layer.

In some embodiments, the embossed roofing shingle further comprises a third layer under the second layer, wherein the third layer comprises a scrim layer.

In some embodiments, the embossed roofing shingle further comprises a third layer under the second layer, wherein the third layer comprises a fire-retardant layer.

In some embodiments, the embossed roofing shingle further comprises a third layer under the second layer, wherein the third layer comprises a scrim layer configured to be mechanically attached to the roof deck.

In some embodiments, the embossed roofing shingle further comprises a third layer under the second layer, wherein the third layer comprises a shingle membrane layer configured to be mechanically attached to the roof deck.

In some embodiments, the embossed roofing shingle further comprises a third layer under the second layer, wherein the third layer comprises a torchable membrane layer configured to be mechanically attached to the roof deck.

In some embodiments, the present invention provides a roofing system, comprising: a roof deck; and an embossed roofing shingle located on the roof deck, the embossed roofing shingle comprising: a first layer, and a second layer under the first layer, wherein the first layer comprises an embossed surface, wherein the first layer comprises a thermoplastic polyolefin, and wherein the first layer is exposed to the environment.

In some embodiments, a plurality of embossed roofing shingles are located on the roof deck.

In some embodiments, the second layer adheres the embossed roofing shingle to the roof deck.

In some embodiments, the embossed roofing shingle further comprises a third layer under the second layer, wherein the third layer comprises a scrim layer.

In some embodiments, the embossed roofing shingle further comprises a third layer under the second layer, wherein the third layer comprises a fire-retardant layer.

In some embodiments, the embossed roofing shingle further comprises a third layer under the second layer, wherein the third layer comprises a scrim layer mechanically attached to the roof deck.

In some embodiments, the embossed roofing shingle further comprises a third layer under the second layer, wherein the third layer comprises a shingle membrane layer mechanically attached to the roof deck.

In some embodiments, the embossed roofing shingle further comprises a third layer under the second layer, wherein the third layer comprises a torchable membrane layer melted to the roof deck.

In some embodiments, the present invention provides a solar roofing system, comprising: a roof deck; at least one nailable photovoltaic shingle on the roof deck, the at least one nailable photovoltaic shingle comprising at least one solar cell, and a backsheet under the at least one solar cell, wherein the backsheet is mechanically attached to the roof deck; and an embossed roofing shingle located adjacent the at least one nailable photovoltaic shingle on the roof deck, the embossed roofing shingle comprising: a first layer, and a second layer under the first layer, wherein the first layer comprises an embossed surface, wherein the first layer comprises a thermoplastic polyolefin, and wherein the first layer is exposed to the environment.

In some embodiments, a plurality of photovoltaic shingles are on the roof deck.

In some embodiments, a plurality of embossed roofing shingles are on the roof deck.

In some embodiments, the second layer comprises an adhesive.

In some embodiments, the second layer comprises a butyl adhesive.

In some embodiments, the second layer adheres the embossed roofing shingle to the roof deck.

In some embodiments, the embossed roofing further comprises a third layer under the second layer, wherein the third layer comprises a scrim layer.

In some embodiments, the embossed roofing shingle further comprises a third layer under the second layer, wherein the third layer comprises a fire-retardant layer.

In some embodiments, embossed roofing shingle further comprises a third layer under the second layer, wherein the third layer comprises a scrim layer mechanically attached to the roof deck.

In some embodiments, the embossed roofing shingle further comprises a third layer under the second layer, wherein the third layer comprises a shingle membrane layer mechanically attached to the roof deck.

In some embodiments, the embossed roofing shingle further comprises a third layer under the second layer, wherein the third layer comprises a torchable membrane layer melted to the roof deck.

In some embodiments, the present invention provides an embossed membrane, comprising: a first layer, and a second layer under the first layer, wherein the first layer comprises an embossed surface, wherein the first layer comprises a thermoplastic polyolefin, wherein the first layer is configured to be exposed to the environment when the embossed roofing membrane is located on a roof deck, and wherein the second layer comprises a first adhesive.

In some embodiments, the first adhesive comprises a butyl adhesive.

In some embodiments, the embossed membrane further comprises a removable release liner under the second layer, wherein the removable release liner is configured to be removed to expose the second adhesive.

In some embodiments, the embossed membrane further comprises a scrim layer under the second layer.

In some embodiments, the scrim layer is configured to be mechanically attached to a roof deck.

In some embodiments, the embossed membrane further comprises a second adhesive layer under the scrim layer.

In some embodiments, the embossed membrane further comprises a removable release liner under the second adhesive layer, wherein the removable release liner is configured to be removed to expose the second adhesive layer.

In some embodiments, the embossed membrane further comprises a fire-retardant layer under the second layer.

In some embodiments, the fire-retardant layer is configured to be mechanically attached to a roof deck.

In some embodiments, the embossed membrane further comprises a second adhesive layer under the fire-retardant layer.

In some embodiments, the embossed membrane further comprises a removable release liner under the second adhesive layer, wherein the removable release liner is configured to be removed to expose the second adhesive layer.

In some embodiments, the embossed membrane further comprises a shingle membrane layer under the second layer.

In some embodiments, the shingle membrane layer is configured to be mechanically attached to a roof deck.

In some embodiments, the embossed membrane further comprises a torchable membrane layer under the second layer.

In some embodiments, the torchable membrane layer is configured to be mechanically attached to a roof deck.

In some embodiments, the present invention provides a solar roofing system, comprising: a roof deck; at least one nailable photovoltaic shingle installed on the roof deck, the at least one nailable photovoltaic shingle comprising at least one solar cell, and a backsheet under the at least one solar cell, wherein the backsheet is mechanically attached to the roof deck; and a plurality of embossed roofing shingles installed on the roof deck adjacent to the at least one nailable photovoltaic shingle on the roof deck, wherein the plurality of embossed roofing shingles comprising a first embossed roofing shingle, wherein the first embossed roofing shingle comprises: a first layer, and a second layer under the first layer, wherein the first layer comprises an embossed surface, wherein the first layer comprises a thermoplastic polyolefin, and wherein the first layer is exposed to the environment.

In some embodiments, the second layer comprises an adhesive.

In some embodiments, the second layer comprises a butyl adhesive.

In some embodiments, the second layer adheres the first embossed roofing shingle to the roof deck.

In some embodiments, the first embossed roofing shingle further comprises: a third layer under the second layer, wherein the third layer comprises a scrim layer.

In some embodiments, the scrim layer comprises fiberglass.

In some embodiments, the scrim layer comprises a fiberglass-reinforced scrim layer.

In some embodiments, the first embossed roofing shingle further comprises: a third layer under the second layer, wherein the third layer comprises a fire-retardant layer.

In some embodiments, the first embossed roofing shingle further comprises: a third layer under the second layer, wherein the third layer comprises a shingle membrane layer.

In some embodiments, the solar roofing system further comprises a plurality of fasteners, wherein the plurality of fasteners comprises at least a first fastener and a second fastener, wherein the first fastener penetrates the roof deck and the at least one nailable photovoltaic shingle, wherein the second fastener penetrates the first embossed roofing shingle.

In some embodiments, the first embossed roofing shingle further comprises: a third layer under the second layer, wherein the third layer comprises a torchable membrane layer melted to the roof deck.

In some embodiments, the solar roofing system further comprises: a plurality of fasteners, wherein the plurality of fasteners comprises at least a first fastener and a second fastener, wherein the first fastener penetrates the roof deck and the at least one nailable photovoltaic shingle, wherein the second fastener penetrates the first embossed roofing shingle.

In some embodiments, the present invention provides a solar roofing system, comprising: a roof deck; at least one nailable photovoltaic shingle installed on the roof deck, the at least one nailable photovoltaic shingle comprising at least one solar cell, and a backsheet under the at least one solar cell, wherein the backsheet is mechanically attached to the roof deck; and at least one non-photovoltaic shingle installed on the roof deck adjacent to the at least one nailable photovoltaic shingle on the roof deck; and an embossed membrane installed between the roof deck and at least one of the at least one nailable photovoltaic shingle and the at least one non-photovoltaic shingle, wherein the embossed membrane comprises: a first layer, and a second layer under the first layer, wherein the first layer comprises an embossed surface, wherein the first layer comprises a thermoplastic polyolefin, and wherein the second layer is between the first layer and the roof deck.

In some embodiments, the second layer comprises an adhesive.

In some embodiments, the second layer comprises a butyl adhesive.

In some embodiments, the second layer adheres the embossed membrane to the roof deck.

In some embodiments, the embossed membrane further comprises: a third layer under the second layer, wherein the third layer comprises a scrim layer.

In some embodiments, the scrim layer comprises fiberglass.

In some embodiments, the embossed membrane further comprises: a third layer under the second layer, wherein the third layer comprises a fire-retardant layer.

In some embodiments, the embossed membrane further comprises: a third layer under the second layer, wherein the third layer comprises a shingle membrane layer.

### BRIEF DESCRIPTION OF THE DRAWINGS

This section refers to the drawings that form a part of this disclosure, and which illustrate embodiments of materials and methods described herein.

FIG. 1 is an isometric view of a cross section of an embodiment of the present invention.

FIG. 2 is an isometric view of a cross section of another embodiment of the present invention.

FIG. 3 is an isometric view of a cross section of another embodiment of the present invention.

FIG. 4 is an isometric view of a cross section of another embodiment of the present invention.

FIG. 5 is an isometric view of a cross section of another embodiment of the present invention.

FIG. 6 is an isometric view of a cross section of another embodiment of the present invention.

FIG. 7 is an isometric view of a cross section of another embodiment of the present invention.

### DETAILED DESCRIPTION

In addition to the benefits and improvements that the Specification discloses, other objects and advantages of that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising,” “including,” “having,” and any similar phrase, do not limit the scope of a specific claim to the materials or steps recited by the claim.

As used herein, a “steep slope roof” is a roof that is disposed on a building, such as a house or other residential structure, having a pitch of Y/X, where Y and X are in a ratio of 4:12 to 20:12, where Y corresponds to the “rise” of the roof, and where X corresponds to the “run” of the roof.

In some embodiments, the present invention may provide an embossed roofing shingle. As used herein, a “roofing shingle” may be a roofing component configured to be exposed to the environment when located on a roof deck-that is, a roofing shingle may be a roofing component that is not covered, customarily, by another component installed on the roof deck.

In some embodiments, the embossed roofing shingle may have a surface that is embossed mechanically. In some embodiments, the mechanically-embossed surface may be embossed by one roller. In some embodiments, the mechanically-embossed surface may be embossed by more than one roller. In some embodiments, the mechanically-embossed surface may be embossed by two rollers. In some embodiments, the mechanically-embossed surface may be embossed by more than two rollers. In some embodiments, the mechanically-embossed surface may be embossed by one or more rollers that are textured. In some embodiments, the mechanically-embossed surface may be embossed by one or more rollers that are textured, and one or more rollers that are untextured (e.g., smooth). In some embodiments, the mechanically-embossed surface may be embossed by one or more rollers that are heated. In some embodiments, the mechanically-embossed surface may be embossed by one or more rollers that are unheated. In some embodiments, the mechanically-embossed surface may be embossed by one or more rollers that are heated, and one or more rollers that are unheated.

In some embodiments, the embossed roofing shingle may have an embossed surface—that is a surface with one or more higher areas, and the surface having one or more lower areas. In some embodiments, the embossed roofing shingle may have an embossed surface with a repeating pattern of higher areas separated from each other by channels. In some embodiments, the higher areas may be diamond shaped. In some embodiments, the higher areas may be square shaped. In some embodiments, the higher areas may be triangle shaped. In some embodiments, the higher areas may be rectangle shaped. In some embodiments, the higher areas may be circle shaped. In some embodiments, the higher areas may be oval shaped. In some embodiments, the higher areas may be another shape. In some embodiments, the lower areas (e.g., channels) may be more than one parallel line. In some embodiments, the lower areas (e.g., channels) may be two sets of parallel lines, which intersect one another.

In some embodiments, the embossed roofing shingle may have a same general visual appearance as a photovoltaic shingle. Accordingly, in some embodiments, one or more of the embossed roofing shingle may be installed on a roof deck on which one or more of the photovoltaic shingles are installed and/or are to be installed.

In some embodiments, the embossed roofing shingle may be installed directly on a roof deck—that is, with no intervening layer between the shingle and the roof deck. In some embodiments, the embossed roofing shingle may be installed with one or more layers intervening between the shingle and the roof deck—such as, for example, a roofing underlayment as an intervening layer.

In some embodiments, the embossed roofing shingle may include a first layer, and a second layer under the first layer. In some embodiments, the first layer may comprise the embossed surface. In some embodiments, the first layer may comprise a thermoplastic polyolefin (TPO). In some embodiments, the first layer may comprise polyvinylchloride (PVC). In some embodiments, the first layer may comprise ethylene propylene diene monomer (EPDM). In some embodiments, the first layer may be configured to be exposed to the environment when the embossed roofing shingle is located on the roof deck.

In some embodiments, the first layer may have a thickness of 10 mil. In some embodiments, the first layer may have a thickness of 20 mil. In some embodiments, the first layer may have a thickness of 25 mil. In some embodiments, the first layer may have a thickness of 30 mil. In some embodiments, the first layer may have a thickness of 40 mil. In some embodiments, the first layer may have a thickness of 50 mil. In some embodiments, the first layer may have a thickness of 60 mil. In some embodiments, the first layer may have a thickness of 70 mil. In some embodiments, the first layer may have a thickness of 75 mil. In some embodiments, the first layer may have a thickness of 80 mil. In some embodiments, the first layer may have a thickness of 90 mil. In some embodiments, the first layer may have a thickness of 100 mil. In some embodiments, the first layer may have a thickness of 110 mil. In some embodiments, the first layer may have a thickness of 10 mil to 110 mil. In some embodiments, the first layer may have a thickness of 10 mil to 100 mil. In some embodiments, the first layer may have a thickness of 10 mil to 90 mil. In some embodiments, the first layer may have a thickness of 10 mil to 80 mil. In some embodiments, the first layer may have a thickness of 10 mil to 75 mil. In some embodiments, the first layer may have a thickness of 10 mil to 70 mil. In some embodiments, the first layer may have a thickness of 10 mil to 60 mil. In some embodiments, the first layer may have a thickness of 10 mil to 50 mil. In some embodiments, the first layer may have a thickness of 10 mil to 40 mil. In some embodiments, the first layer may have a thickness of 10 mil to 30 mil. In some embodiments, the first layer may have a thickness of 10 mil to 25 mil. In some embodiments, the first layer may have a thickness of 10 mil to 20 mil. In some embodiments, the first layer may have a thickness of 20 mil to 110 mil. In some embodiments, the first layer may have a thickness of 20 mil to 100 mil. In some embodiments, the first layer may have a thickness of 20 mil to 90 mil. In some embodiments, the first layer may have a thickness of 20 mil to 80 mil. In some embodiments, the first layer may have a thickness of 20 mil to 75 mil. In some embodiments, the first layer may have a thickness of 20 mil to 70 mil. In some embodiments, the first layer may have a thickness of 20 mil to 60 mil. In some embodiments, the first layer may have a thickness of 20 mil to 50 mil. In some embodiments, the first layer may have a thickness of 20 mil to 40 mil. In some embodiments, the first layer may have a thickness of 20 mil to 30 mil. In some embodiments, the first layer may have a thickness of 20 mil to 25 mil. In some embodiments, the first layer may have a thickness of 25 mil to 110 mil. In some embodiments, the first layer may have a thickness of 25 mil to 100 mil. In some embodiments, the first layer may have a thickness of 25 mil to 90 mil. In some embodiments, the first layer may have a thickness of 25 mil to 80 mil. In some embodiments, the first layer may have a thickness of 25 mil to 75 mil. In some embodiments, the first layer may have a thickness of 25 mil to 70 mil. In some embodiments, the first layer may have a thickness of 25 mil to 60 mil. In some embodiments, the first layer may have a thickness of 25 mil to 50 mil. In some embodiments, the first layer may have a thickness of 25 mil to 40 mil. In some embodiments, the first layer may have a thickness of 25 mil to 30 mil. In some embodiments, the first layer may have a thickness of 30 mil to 110 mil. In some embodiments, the first layer may have a thickness of 30 mil to 100 mil. In some embodiments, the first layer may have a thickness of 30 mil to 90 mil. In some embodiments, the first layer may have a thickness of 30 mil to 80 mil. In some embodiments, the first layer may have a thickness of 30 mil to 75 mil. In some embodiments, the first layer may have a thickness of 30 mil to 70 mil. In some embodiments, the first layer may have a thickness of 30 mil to 60 mil. In some embodiments, the first layer may have a thickness of 30 mil to 50 mil. In some embodiments, the first layer may have a thickness of 30 mil to 40 mil. In some embodiments, the first layer may have a thickness of 40 mil to 110 mil. In some embodiments, the first layer may have a thickness of 40 mil to 100 mil. In some embodiments, the first layer may have a thickness of 40 mil to 90 mil. In some embodiments, the first layer may have a thickness of 40 mil to 80 mil. In some embodiments, the first layer may have a thickness of 40 mil to 75 mil. In some embodiments, the first layer may have a thickness of 40 mil to 70 mil. In some embodiments, the first layer may have a thickness of 40 mil to 60 mil. In some embodiments, the first layer may have a thickness of 40 mil to 50 mil. In some embodiments, the first layer may have a thickness of 50 mil to 110 mil. In some embodiments, the first layer may have a thickness of 50 mil to 100 mil. In some embodiments, the first layer may have a thickness of 50 mil to 90 mil. In some embodiments, the first layer may have a thickness of 50 mil to 80 mil. In some embodiments, the first layer may have a thickness of 50 mil to 75 mil. In some embodiments, the first layer may have a thickness of 50 mil to 70 mil. In some embodiments, the first layer may have a thickness of 50 mil to 60 mil. In some embodiments, the first layer may have a thickness of 60 mil to 110 mil. In some embodiments, the first layer may have a thickness of 60 mil to 100 mil. In some embodiments, the first layer may have a thickness of 60 mil to 90 mil. In some embodiments, the first layer may have a thickness of 60 mil to 80 mil. In some embodiments, the first layer may have a thickness of 60 mil to 75 mil. In some embodiments, the first layer may have a thickness of 60 mil to 70 mil. In some embodiments, the first layer may have a thickness of 70 mil to 110 mil. In some embodiments, the first layer may have a thickness of 70 mil to 100 mil. In some embodiments, the first layer may have a thickness of 70 mil to 90 mil. In some embodiments, the first layer may have a thickness of 70 mil to 80 mil. In some embodiments, the first layer may have a thickness of 70 mil to 75 mil. In some embodiments, the first layer may have a thickness of 80 mil to 110 mil. In some embodiments, the first layer may have a thickness of 80 mil to 100 mil. In some embodiments, the first layer may have a thickness of 80 mil to 90 mil. In some embodiments, the first layer may have a thickness of 90 mil to 100 mil. In some embodiments, the first layer may have a thickness of 90 mil to 110 mil.

In some embodiments, the first layer may have a weight of 580 GSM. In some embodiments, the first layer may have a weight of 644 GSM. In some embodiments, the first layer may have a weight of 1442 GSM. In some embodiments, the first layer may have a weight of 1444 GSM. In some embodiments, the first layer may have a weight of 1968 GSM. In some embodiments, the first layer may have a weight of 2400 GSM. In some embodiments, the first layer may have a weight of 3200 GSM. In some embodiments, the first layer may have a weight of 580 GSM to 1968 GSM. In some embodiments, the first layer may have a weight of less than 580 GSM. In some embodiments, the first layer may have a weight of more than 1968 GSM.

In some embodiments, the second layer may comprise an adhesive. In some embodiments, the second layer may comprise a butyl adhesive. In some embodiments, the butyl adhesive may comprise CaCO₃. In some embodiments, the butyl adhesive may comprise MgOH. In some embodiments, the butyl adhesive may comprise MgO. In some embodiments, the butyl adhesive may comprise one, two, three, or none of CaCO₃, MgOH, and/or MgO. In some embodiments, the adhesive may be a thermoset. In some embodiments, the adhesive may be a thermoplastic. In some embodiments where there is a release liner under the adhesive, the adhesive may be a thermoplastic.

In some embodiments, the second layer may have a thickness of 15 mil. In some embodiments, the second layer may have a thickness of 16 mil. In some embodiments, the second layer may have a thickness of 17 mil. In some embodiments, the second layer may have a thickness of 18 mil. In some embodiments, the second layer may have a thickness of 19 mil. In some embodiments, the second layer may have a thickness of 20 mil. In some embodiments, the second layer may have a thickness of 21 mil. In some embodiments, the second layer may have a thickness of 22 mil. In some embodiments, the second layer may have a thickness of 23 mil. In some embodiments, the second layer may have a thickness of 24 mil. In some embodiments, the second layer may have a thickness of 25 mil. In some embodiments, the second layer may have a thickness of 26 mil. In some embodiments, the second layer may have a thickness of 27 mil. In some embodiments, the second layer may have a thickness of 28 mil. In some embodiments, the second layer may have a thickness of 29 mil. In some embodiments, the second layer may have a thickness of 30 mil. In some embodiments, the second layer may have a thickness of 15 mil to 30 mil. In some embodiments, the second layer may have a thickness of 15 mil to 29 mil. In some embodiments, the second layer may have a thickness of 15 mil to 28 mil. In some embodiments, the second layer may have a thickness of 15 mil to 27 mil. In some embodiments, the second layer may have a thickness of 15 mil to 26 mil. In some embodiments, the second layer may have a thickness of 15 mil to 25 mil. In some embodiments, the second layer may have a thickness of 15 mil to 24 mil. In some embodiments, the second layer may have a thickness of 15 mil to 23 mil. In some embodiments, the second layer may have a thickness of 15 mil to 22 mil. In some embodiments, the second layer may have a thickness of 15 mil to 21 mil. In some embodiments, the second layer may have a thickness of 15 mil to 20 mil. In some embodiments, the second layer may have a thickness of 15 mil to 19 mil. In some embodiments, the second layer may have a thickness of 15 mil to 18 mil. In some embodiments, the second layer may have a thickness of 15 mil to 17 mil. In some embodiments, the second layer may have a thickness of 15 mil to 16 mil. In some embodiments, the second layer may have a thickness of 16 mil to 30 mil. In some embodiments, the second layer may have a thickness of 16 mil to 29 mil. In some embodiments, the second layer may have a thickness of 16 mil to 28 mil. In some embodiments, the second layer may have a thickness of 16 mil to 27 mil. In some embodiments, the second layer may have a thickness of 16 mil to 26 mil. In some embodiments, the second layer may have a thickness of 16 mil to 25 mil. In some embodiments, the second layer may have a thickness of 16 mil to 24 mil. In some embodiments, the second layer may have a thickness of 16 mil to 23 mil. In some embodiments, the second layer may have a thickness of 16 mil to 22 mil. In some embodiments, the second layer may have a thickness of 16 mil to 21 mil. In some embodiments, the second layer may have a thickness of 16 mil to 20 mil. In some embodiments, the second layer may have a thickness of 16 mil to 19 mil. In some embodiments, the second layer may have a thickness of 16 mil to 18 mil. In some embodiments, the second layer may have a thickness of 16 mil to 17 mil. In some embodiments, the second layer may have a thickness of 17 mil to 30 mil. In some embodiments, the second layer may have a thickness of 17 mil to 29 mil. In some embodiments, the second layer may have a thickness of 17 mil to 28 mil. In some embodiments, the second layer may have a thickness of 17 mil to 27 mil. In some embodiments, the second layer may have a thickness of 17 mil to 26 mil. In some embodiments, the second layer may have a thickness of 17 mil to 25 mil. In some embodiments, the second layer may have a thickness of 17 mil to 24 mil. In some embodiments, the second layer may have a thickness of 17 mil to 23 mil. In some embodiments, the second layer may have a thickness of 17 mil to 22 mil. In some embodiments, the second layer may have a thickness of 17 mil to 21 mil. In some embodiments, the second layer may have a thickness of 17 mil to 20 mil. In some embodiments, the second layer may have a thickness of 17 mil to 19 mil. In some embodiments, the second layer may have a thickness of 17 mil to 18 mil. In some embodiments, the second layer may have a thickness of 18 mil to 30 mil. In some embodiments, the second layer may have a thickness of 18 mil to 29 mil. In some embodiments, the second layer may have a thickness of 18 mil to 28 mil. In some embodiments, the second layer may have a thickness of 18 mil to 27 mil. In some embodiments, the second layer may have a thickness of 18 mil to 26 mil. In some embodiments, the second layer may have a thickness of 18 mil to 25 mil. In some embodiments, the second layer may have a thickness of 18 mil to 24 mil. In some embodiments, the second layer may have a thickness of 18 mil to 23 mil. In some embodiments, the second layer may have a thickness of 18 mil to 22 mil. In some embodiments, the second layer may have a thickness of 18 mil to 21 mil. In some embodiments, the second layer may have a thickness of 18 mil to 20 mil. In some embodiments, the second layer may have a thickness of 18 mil to 19 mil. In some embodiments, the second layer may have a thickness of 19 mil to 30 mil. In some embodiments, the second layer may have a thickness of 19 mil to 29 mil. In some embodiments, the second layer may have a thickness of 19 mil to 28 mil. In some embodiments, the second layer may have a thickness of 19 mil to 27 mil. In some embodiments, the second layer may have a thickness of 19 mil to 26 mil. In some embodiments, the second layer may have a thickness of 19 mil to 25 mil. In some embodiments, the second layer may have a thickness of 19 mil to 24 mil. In some embodiments, the second layer may have a thickness of 19 mil to 23 mil. In some embodiments, the second layer may have a thickness of 19 mil to 22 mil. In some embodiments, the second layer may have a thickness of 19 mil to 21 mil. In some embodiments, the second layer may have a thickness of 19 mil to 20 mil. In some embodiments, the second layer may have a thickness of 20 mil to 30 mil. In some embodiments, the second layer may have a thickness of 20 mil to 29 mil. In some embodiments, the second layer may have a thickness of 20 mil to 28 mil. In some embodiments, the second layer may have a thickness of 20 mil to 27 mil. In some embodiments, the second layer may have a thickness of 20 mil to 26 mil. In some embodiments, the second layer may have a thickness of 20 mil to 25 mil. In some embodiments, the second layer may have a thickness of 20 mil to 24 mil. In some embodiments, the second layer may have a thickness of 20 mil to 23 mil. In some embodiments, the second layer may have a thickness of 20 mil to 22 mil. In some embodiments, the second layer may have a thickness of 20 mil to 21 mil. In some embodiments, the second layer may have a thickness of 21 mil to 30 mil. In some embodiments, the second layer may have a thickness of 21 mil to 29 mil. In some embodiments, the second layer may have a thickness of 21 mil to 28 mil. In some embodiments, the second layer may have a thickness of 21 mil to 27 mil. In some embodiments, the second layer may have a thickness of 21 mil to 26 mil. In some embodiments, the second layer may have a thickness of 21 mil to 25 mil. In some embodiments, the second layer may have a thickness of 21 mil to 24 mil. In some embodiments, the second layer may have a thickness of 21 mil to 23 mil. In some embodiments, the second layer may have a thickness of 21 mil to 22 mil. In some embodiments, the second layer may have a thickness of 22 mil to 30 mil. In some embodiments, the second layer may have a thickness of 22 mil to 29 mil. In some embodiments, the second layer may have a thickness of 22 mil to 28 mil. In some embodiments, the second layer may have a thickness of 22 mil to 27 mil. In some embodiments, the second layer may have a thickness of 22 mil to 26 mil. In some embodiments, the second layer may have a thickness of 22 mil to 25 mil. In some embodiments, the second layer may have a thickness of 22 mil to 24 mil. In some embodiments, the second layer may have a thickness of 22 mil to 23 mil. In some embodiments, the second layer may have a thickness of 23 mil to 30 mil. In some embodiments, the second layer may have a thickness of 23 mil to 29 mil. In some embodiments, the second layer may have a thickness of 23 mil to 28 mil. In some embodiments, the second layer may have a thickness of 23 mil to 27 mil. In some embodiments, the second layer may have a thickness of 23 mil to 26 mil. In some embodiments, the second layer may have a thickness of 23 mil to 25 mil. In some embodiments, the second layer may have a thickness of 23 mil to 24 mil. In some embodiments, the second layer may have a thickness of 24 mil to 30 mil. In some embodiments, the second layer may have a thickness of 24 mil to 29 mil. In some embodiments, the second layer may have a thickness of 24 mil to 28 mil. In some embodiments, the second layer may have a thickness of 24 mil to 27 mil. In some embodiments, the second layer may have a thickness of 24 mil to 26 mil. In some embodiments, the second layer may have a thickness of 24 mil to 25 mil. In some embodiments, the second layer may have a thickness of 25 mil to 30 mil. In some embodiments, the second layer may have a thickness of 25 mil to 29 mil. In some embodiments, the second layer may have a thickness of 25 mil to 28 mil. In some embodiments, the second layer may have a thickness of 25 mil to 27 mil. In some embodiments, the second layer may have a thickness of 25 mil to 26 mil. In some embodiments, the second layer may have a thickness of 26 mil to 30 mil. In some embodiments, the second layer may have a thickness of 26 mil to 29 mil. In some embodiments, the second layer may have a thickness of 26 mil to 28 mil. In some embodiments, the second layer may have a thickness of 26 mil to 27 mil. In some embodiments, the second layer may have a thickness of 27 mil to 30 mil. In some embodiments, the second layer may have a thickness of 27 mil to 29 mil. In some embodiments, the second layer may have a thickness of 27 mil to 28 mil. In some embodiments, the second layer may have a thickness of 28 mil to 30 mil. In some embodiments, the second layer may have a thickness of 28 mil to 29 mil. In some embodiments, the second layer may have a thickness of 29 mil to 30 mil.

In some embodiments, the second layer may have a weight of 200 GSM. In some embodiments, the second layer may have a weight of 725 GSM. In some embodiments, the second layer may have a weight of 1000 GSM. In some embodiments, the second layer may have a weight of 200 GSM to 1000 GSM. In some embodiments, the second layer may have a weight of less than 200 GSM. In some embodiments, the second layer may have a weight of more than 1000 GSM. In some embodiments, the second layer may be configured to adhere the embossed roofing shingle to the roof deck.

In some embodiments, the embossed roofing shingle may further comprise a removable release liner under the second layer. In some embodiments, the removable release liner may be configured to be removed to expose the second layer. In some embodiments, the release liner may be a silicone release liner. In some embodiments, the exposed second layer may be used to adhere the embossed roofing shingle to a roof deck.

In some embodiments, the silicone release liner may be single sided (that is, with silicone on one side). In some embodiments, the silicone release liner may be double sided (that is, with silicone on both sides). In some embodiments, the silicone release liner may be polypropylene (PP). In some embodiments, the silicone release liner may be polyethylene (PE). In some embodiments, the silicone release liner may be polyethylene terephthalate (PET). In some embodiments, the silicone release liner may be nylon. In some embodiments, the silicone release liner may be paper based. In some embodiments, the silicone release liner may have a weight of 25 GSM. In some embodiments, the silicone release liner may have a weight of 160 GSM. In some embodiments, the silicone release liner may have a weight of 25 GSM to 160 GSM. In some embodiments, the silicone release liner may have a weight of less than 25 GSM. In some embodiments, the silicone release liner may have a weight of more than 160 GSM.

In some embodiments, the embossed roofing shingle may further comprise a third layer under the second layer.

In some embodiments, the third layer may comprise a scrim layer. In some embodiments, the scrim layer may comprise a fiberglass-reinforced scrim layer.

In some embodiments, one or both side of the scrim layer may be coated with a coating. In some embodiments, the second layer may contact a non-coated side of the scrim layer, such as a fiberglass-reinforced scrim layer. In some embodiments, the second layer may contact a coated side of the scrim layer, such as a fiberglass-reinforced scrim layer. In some embodiments, the coating may be one or more of acrylic, ethylene-vinyl acetate (EVA), polyurethane, and/or polyvinylchloride. In some embodiments, the coating may include a color pigment. In some embodiments, the coating may comprise an expandable graphite filler. In some embodiments, a percentage of expandable graphite may be 0% to 70%. In some embodiments, a weight of the coating may be 25 GSM to 220 GSM. In some embodiments, a thickness of the coating may be 1 mil to 30 mil.

In some embodiments, the scrim layer may be configured to be mechanically attached to the roof deck. In some embodiments, a second adhesive layer may be under the third layer. In some embodiments, the second adhesive may comprise a butyl adhesive. In some embodiments, a removable release liner may be under the second adhesive. In some embodiments, the removable release liner may be configured to be removed to expose the second adhesive. In some embodiments, the release liner may be a silicone release liner.

In some embodiments, mechanical attachment may be provided by one or more of at least one nail, screw, staple, and/or other penetrating fastener. In some embodiments, one or more of the fasteners penetrate the nailable photovoltaic shingle, and/or the shingle in accordance with the invention, and/or the membrane in accordance with the invention, as well as the roof deck, thereby to install the nailable photovoltaic shingle, membrane, and/or shingle to the roof deck. In some embodiments, the nailable photovoltaic shingle includes at least one solar cell. In some embodiments, the at least one solar cell includes a plurality of solar cells. In some embodiments, the nailable photovoltaic shingle includes a backsheet under the at least one solar cell. In some embodiments, a portion of the nailable photovoltaic shingle, such as but not limited to the backsheet, is mechanically attached to the roof deck. In some embodiments, the mechanical attachment includes one or more nails, screw, bolts, rivets, staples, and/or combinations thereof, which penetrate the backsheet and the roof deck, thereby to install the nailable photovoltaic shingle in a solar roofing system that includes one or more non-photovoltaic shingles.

In some embodiments, the fiberglass-reinforced scrim layer may have a thickness of 15 mil. In some embodiments, the fiberglass-reinforced scrim layer may have a thickness of 16 mil. In some embodiments, the fiberglass-reinforced scrim layer may have a thickness of 17 mil. In some embodiments, the fiberglass-reinforced scrim layer may have a thickness of 18 mil. In some embodiments, the fiberglass-reinforced scrim layer may have a thickness of 19 mil. In some embodiments, the fiberglass-reinforced scrim layer may have a thickness of 20 mil. In some embodiments, the fiberglass-reinforced scrim layer may have a thickness of 21 mil. In some embodiments, the fiberglass-reinforced scrim layer may have a thickness of 22 mil. In some embodiments, the fiberglass-reinforced scrim layer may have a thickness of 23 mil. In some embodiments, the fiberglass-reinforced scrim layer may have a thickness of 24 mil. In some embodiments, the fiberglass-reinforced scrim layer may have a thickness of 25 mil. In some embodiments, the fiberglass-reinforced scrim layer may have a thickness of 15 mil to 25 mil. In some embodiments, the fiberglass-reinforced scrim layer may have a thickness of 15 mil to 24 mil. In some embodiments, the fiberglass-reinforced scrim layer may have a thickness of 15 mil to 23 mil. In some embodiments, the fiberglass-reinforced scrim layer may have a thickness of 15 mil to 22 mil. In some embodiments, the fiberglass-reinforced scrim layer may have a thickness of 15 mil to 21 mil. In some embodiments, the fiberglass-reinforced scrim layer may have a thickness of 15 mil to 20 mil. In some embodiments, the fiberglass-reinforced scrim layer may have a thickness of 15 mil to 19 mil. In some embodiments, the fiberglass-reinforced scrim layer may have a thickness of 15 mil to 18 mil. In some embodiments, the fiberglass-reinforced scrim layer may have a thickness of 15 mil to 17 mil. In some embodiments, the fiberglass-reinforced scrim layer may have a thickness of 15 mil to 16 mil. In some embodiments, the fiberglass-reinforced scrim layer may have a thickness of 16 mil to 25 mil. In some embodiments, the fiberglass-reinforced scrim layer may have a thickness of 16 mil to 24 mil. In some embodiments, the fiberglass-reinforced scrim layer may have a thickness of 16 mil to 23 mil. In some embodiments, the fiberglass-reinforced scrim layer may have a thickness of 16 mil to 22 mil. In some embodiments, the fiberglass-reinforced scrim layer may have a thickness of 16 mil to 21 mil. In some embodiments, the fiberglass-reinforced scrim layer may have a thickness of 16 mil to 20 mil. In some embodiments, the fiberglass-reinforced scrim layer may have a thickness of 16 mil to 19 mil. In some embodiments, the fiberglass-reinforced scrim layer may have a thickness of 16 mil to 18 mil. In some embodiments, the fiberglass-reinforced scrim layer may have a thickness of 16 mil to 17 mil. In some embodiments, the fiberglass-reinforced scrim layer may have a thickness of 17 mil to 25 mil. In some embodiments, the fiberglass-reinforced scrim layer may have a thickness of 17 mil to 24 mil. In some embodiments, the fiberglass-reinforced scrim layer may have a thickness of 17 mil to 23 mil. In some embodiments, the fiberglass-reinforced scrim layer may have a thickness of 17 mil to 22 mil. In some embodiments, the fiberglass-reinforced scrim layer may have a thickness of 17 mil to 21 mil. In some embodiments, the fiberglass-reinforced scrim layer may have a thickness of 17 mil to 20 mil. In some embodiments, the fiberglass-reinforced scrim layer may have a thickness of 17 mil to 19 mil. In some embodiments, the fiberglass-reinforced scrim layer may have a thickness of 17 mil to 18 mil. In some embodiments, the fiberglass-reinforced scrim layer may have a thickness of 18 mil to 25 mil. In some embodiments, the fiberglass-reinforced scrim layer may have a thickness of 18 mil to 24 mil. In some embodiments, the fiberglass-reinforced scrim layer may have a thickness of 18 mil to 23 mil. In some embodiments, the fiberglass-reinforced scrim layer may have a thickness of 18 mil to 22 mil. In some embodiments, the fiberglass-reinforced scrim layer may have a thickness of 18 mil to 21 mil. In some embodiments, the fiberglass-reinforced scrim layer may have a thickness of 18 mil to 20 mil. In some embodiments, the fiberglass-reinforced scrim layer may have a thickness of 18 mil to 19 mil. In some embodiments, the fiberglass-reinforced scrim layer may have a thickness of 19 mil to 25 mil. In some embodiments, the fiberglass-reinforced scrim layer may have a thickness of 19 mil to 24 mil. In some embodiments, the fiberglass-reinforced scrim layer may have a thickness of 19 mil to 23 mil. In some embodiments, the fiberglass-reinforced scrim layer may have a thickness of 19 mil to 22 mil. In some embodiments, the fiberglass-reinforced scrim layer may have a thickness of 19 mil to 21 mil. In some embodiments, the fiberglass-reinforced scrim layer may have a thickness of 19 mil to 20 mil. In some embodiments, the fiberglass-reinforced scrim layer may have a thickness of 20 mil to 25 mil. In some embodiments, the fiberglass-reinforced scrim layer may have a thickness of 20 mil to 24 mil. In some embodiments, the fiberglass-reinforced scrim layer may have a thickness of 20 mil to 23 mil. In some embodiments, the fiberglass-reinforced scrim layer may have a thickness of 20 mil to 22 mil. In some embodiments, the fiberglass-reinforced scrim layer may have a thickness of 20 mil to 21 mil. In some embodiments, the fiberglass-reinforced scrim layer may have a thickness of 21 mil to 25 mil. In some embodiments, the fiberglass-reinforced scrim layer may have a thickness of 21 mil to 24 mil. In some embodiments, the fiberglass-reinforced scrim layer may have a thickness of 21 mil to 23 mil. In some embodiments, the fiberglass-reinforced scrim layer may have a thickness of 21 mil to 22 mil. In some embodiments, the fiberglass-reinforced scrim layer may have a thickness of 22 mil to 25 mil. In some embodiments, the fiberglass-reinforced scrim layer may have a thickness of 22 mil to 24 mil. In some embodiments, the fiberglass-reinforced scrim layer may have a thickness of 22 mil to 23 mil. In some embodiments, the fiberglass-reinforced scrim layer may have a thickness of 23 mil to 25 mil. In some embodiments, the fiberglass-reinforced scrim layer may have a thickness of 23 mil to 24 mil. In some embodiments, the fiberglass-reinforced scrim layer may have a thickness of 24 mil to 25 mil.

In some embodiments, a fiberglass-reinforced scrim layer may have a weight of 220 GSM. In some embodiments, a fiberglass-reinforced scrim layer may have a weight of 310 GSM. In some embodiments, a fiberglass-reinforced scrim layer may have a weight of 410 GSM. In some embodiments, a fiberglass-reinforced scrim layer may have a weight of 520 GSM. In some embodiments, a fiberglass-reinforced scrim layer may have a weight of 630 GSM. In some embodiments, a fiberglass-reinforced scrim layer may have a weight of less than 220 GSM. In some embodiments, a fiberglass-reinforced scrim layer may have a weight of greater than 630 GSM. In some embodiments, a fiberglass-reinforced scrim layer may have a thickness of 10 mil and a weight of 220 GSM. In some embodiments, a fiberglass-reinforced scrim layer may have a thickness of 12 mil and a weight of 310 GSM. In some embodiments, a fiberglass-reinforced scrim layer may have a thickness of 16 mil and a weight of 410 GSM. In some embodiments, a fiberglass-reinforced scrim layer may have a thickness of 20 mil and a weight of 520 GSM. In some embodiments, a fiberglass-reinforced scrim layer may have a thickness of 24 mil and a weight of 630 GSM.

In some embodiments, the fiberglass-reinforced scrim layer may have a weight of 52 GSM. In some embodiments, the fiberglass-reinforced scrim layer may have a weight of at least 220 GSM. In some embodiments, the fiberglass-reinforced scrim layer may have a weight of 220 GSM. In some embodiments, the fiberglass-reinforced scrim layer may have a weight of greater than 220 GSM.

In some embodiments, with the embossed roofing shingle with a first TPO layer, a second butyl adhesive layer under the first layer, and a third fiberglass-reinforced scrim layer under the second layer, may have a total thickness of 120 mils.

In some embodiments, the third layer may comprise a fire-retardant layer. In some embodiments, the fire-retardant layer may comprise a fiberglass-reinforced fire-retardant layer. In some embodiments, the fire-retardant layer may be configured to be mechanically attached to the roof deck. In some embodiments, a second adhesive layer may be under the third layer. In some embodiments, the second adhesive may comprise a butyl adhesive. In some embodiments, a removable release liner may be under the second adhesive. In some embodiments, the removable release liner may be configured to be removed to expose the second adhesive. In some embodiments, the release liner may be a silicone release liner.

In some embodiments, the fiberglass-reinforced fire-retardant layer may have a thickness of 25 mil. In some embodiments, the fiberglass-reinforced fire-retardant layer may have a thickness of 26 mil. In some embodiments, the fiberglass-reinforced fire-retardant layer may have a thickness of 27 mil. In some embodiments, the fiberglass-reinforced fire-retardant layer may have a thickness of 28 mil. In some embodiments, the fiberglass-reinforced fire-retardant layer may have a thickness of 29 mil. In some embodiments, the fiberglass-reinforced fire-retardant layer may have a thickness of 30 mil. In some embodiments, the fiberglass-reinforced fire-retardant layer may have a thickness of 31 mil. In some embodiments, the fiberglass-reinforced fire-retardant layer may have a thickness of 32 mil. In some embodiments, the fiberglass-reinforced fire-retardant layer may have a thickness of 33 mil. In some embodiments, the fiberglass-reinforced fire-retardant layer may have a thickness of 34 mil. In some embodiments, the fiberglass-reinforced fire-retardant layer may have a thickness of 35 mil. In some embodiments, the fiberglass-reinforced fire-retardant layer may have a thickness of 25 mil to 35 mil. In some embodiments, the fiberglass-reinforced fire-retardant layer may have a thickness of 25 mil to 34 mil. In some embodiments, the fiberglass-reinforced fire-retardant layer may have a thickness of 25 mil to 33 mil. In some embodiments, the fiberglass-reinforced fire-retardant layer may have a thickness of 25 mil to 32 mil. In some embodiments, the fiberglass-reinforced fire-retardant layer may have a thickness of 25 mil to 31 mil. In some embodiments, the fiberglass-reinforced fire-retardant layer may have a thickness of 25 mil to 30 mil. In some embodiments, the fiberglass-reinforced fire-retardant layer may have a thickness of 25 mil to 29 mil. In some embodiments, the fiberglass-reinforced fire-retardant layer may have a thickness of 25 mil to 28 mil. In some embodiments, the fiberglass-reinforced fire-retardant layer may have a thickness of 25 mil to 27 mil. In some embodiments, the fiberglass-reinforced fire-retardant layer may have a thickness of 25 mil to 26 mil. In some embodiments, the fiberglass-reinforced fire-retardant layer may have a thickness of 26 mil to 35 mil. In some embodiments, the fiberglass-reinforced fire-retardant layer may have a thickness of 26 mil to 34 mil. In some embodiments, the fiberglass-reinforced fire-retardant layer may have a thickness of 26 mil to 33 mil. In some embodiments, the fiberglass-reinforced fire-retardant layer may have a thickness of 26 mil to 32 mil. In some embodiments, the fiberglass-reinforced fire-retardant layer may have a thickness of 26 mil to 31 mil. In some embodiments, the fiberglass-reinforced fire-retardant layer may have a thickness of 26 mil to 30 mil. In some embodiments, the fiberglass-reinforced fire-retardant layer may have a thickness of 26 mil to 29 mil. In some embodiments, the fiberglass-reinforced fire-retardant layer may have a thickness of 26 mil to 28 mil. In some embodiments, the fiberglass-reinforced fire-retardant layer may have a thickness of 26 mil to 27 mil. In some embodiments, the fiberglass-reinforced fire-retardant layer may have a thickness of 27 mil to 35 mil. In some embodiments, the fiberglass-reinforced fire-retardant layer may have a thickness of 27 mil to 34 mil. In some embodiments, the fiberglass-reinforced fire-retardant layer may have a thickness of 27 mil to 33 mil. In some embodiments, the fiberglass-reinforced fire-retardant layer may have a thickness of 27 mil to 32 mil. In some embodiments, the fiberglass-reinforced fire-retardant layer may have a thickness of 27 mil to 31 mil. In some embodiments, the fiberglass-reinforced fire-retardant layer may have a thickness of 27 mil to 30 mil. In some embodiments, the fiberglass-reinforced fire-retardant layer may have a thickness of 27 mil to 29 mil. In some embodiments, the fiberglass-reinforced fire-retardant layer may have a thickness of 27 mil to 28 mil. In some embodiments, the fiberglass-reinforced fire-retardant layer may have a thickness of 28 mil to 35 mil. In some embodiments, the fiberglass-reinforced fire-retardant layer may have a thickness of 28 mil to 34 mil. In some embodiments, the fiberglass-reinforced fire-retardant layer may have a thickness of 28 mil to 33 mil. In some embodiments, the fiberglass-reinforced fire-retardant layer may have a thickness of 28 mil to 32 mil. In some embodiments, the fiberglass-reinforced fire-retardant layer may have a thickness of 28 mil to 31 mil. In some embodiments, the fiberglass-reinforced fire-retardant layer may have a thickness of 28 mil to 30 mil. In some embodiments, the fiberglass-reinforced fire-retardant layer may have a thickness of 28 mil to 29 mil. In some embodiments, the fiberglass-reinforced fire-retardant layer may have a thickness of 29 mil to 35 mil. In some embodiments, the fiberglass-reinforced fire-retardant layer may have a thickness of 29 mil to 34 mil. In some embodiments, the fiberglass-reinforced fire-retardant layer may have a thickness of 29 mil to 33 mil. In some embodiments, the fiberglass-reinforced fire-retardant layer may have a thickness of 29 mil to 32 mil. In some embodiments, the fiberglass-reinforced fire-retardant layer may have a thickness of 29 mil to 31 mil. In some embodiments, the fiberglass-reinforced fire-retardant layer may have a thickness of 29 mil to 30 mil. In some embodiments, the fiberglass-reinforced fire-retardant layer may have a thickness of 30 mil to 35 mil. In some embodiments, the fiberglass-reinforced fire-retardant layer may have a thickness of 30 mil to 34 mil. In some embodiments, the fiberglass-reinforced fire-retardant layer may have a thickness of 30 mil to 33 mil. In some embodiments, the fiberglass-reinforced fire-retardant layer may have a thickness of 30 mil to 32 mil. In some embodiments, the fiberglass-reinforced fire-retardant layer may have a thickness of 30 mil to 31 mil. In some embodiments, the fiberglass-reinforced fire-retardant layer may have a thickness of 31 mil to 35 mil. In some embodiments, the fiberglass-reinforced fire-retardant layer may have a thickness of 31 mil to 34 mil. In some embodiments, the fiberglass-reinforced fire-retardant layer may have a thickness of 31 mil to 33 mil. In some embodiments, the fiberglass-reinforced fire-retardant layer may have a thickness of 31 mil to 32 mil. In some embodiments, the fiberglass-reinforced fire-retardant layer may have a thickness of 32 mil to 35 mil. In some embodiments, the fiberglass-reinforced fire-retardant layer may have a thickness of 32 mil to 34 mil. In some embodiments, the fiberglass-reinforced fire-retardant layer may have a thickness of 32 mil to 33 mil. In some embodiments, the fiberglass-reinforced fire-retardant layer may have a thickness of 33 mil to 35 mil. In some embodiments, the fiberglass-reinforced fire-retardant layer may have a thickness of 33 mil to 34 mil. In some embodiments, the fiberglass-reinforced fire-retardant layer may have a thickness of 34 mil to 35 mil.

In some embodiments, the fiberglass-reinforced fire-retardant layer may have a weight of 87 GSM.

In some embodiments, with the embossed roofing shingle with a first TPO layer, a second butyl adhesive layer under the first layer, and a third fiberglass-reinforced fire-retardant layer under the second layer, may have a total thickness of 130 mils.

In some embodiments, the third layer may comprise a shingle membrane layer. In some embodiments, the shingle membrane may be an asphalt shingle. In some embodiments, the shingle membrane may include granules on a top surface thereof. In some embodiments, shingle membrane layer may be configured to be mechanically attached to the roof deck.

In some embodiments, an adhesive may be used to adhere the shingle membrane to the roof deck. In some embodiments, the adhesive may be a butyl adhesive layer. In some embodiments, a release liner may cover the adhesive, such as the butyl adhesive layer.

In some embodiments, the embossed roofing shingle or embossed membrane, including fiberglass, may have a total thickness of 37 mil. In some embodiments, the embossed roofing shingle or embossed membrane, including fiberglass, may have a total thickness of 240 mil. In some embodiments, the embossed roofing shingle or embossed membrane, including fiberglass, may have a total thickness of between 37 mil to 240 mil.

In some embodiments, the shingle membrane layer may have a thickness of 30 mil. In some embodiments, the shingle membrane layer may have a thickness of 40 mil. In some embodiments, the shingle membrane layer may have a thickness of 45 mil. In some embodiments, the shingle membrane layer may have a thickness of 50 mil. In some embodiments, the shingle membrane layer may have a thickness of 60 mil. In some embodiments, the shingle membrane layer may have a thickness of 63 mil. In some embodiments, the shingle membrane layer may have a thickness of 80 mil. In some embodiments, the shingle membrane layer may have a thickness of 103 mil. In some embodiments, the shingle membrane layer may have a thickness of 104 mil. In some embodiments, the shingle membrane layer may have a thickness of 110 mil. In some embodiments, the shingle membrane layer may have a thickness of 120 mil. In some embodiments, the shingle membrane layer may have a thickness of 130 mil. In some embodiments, the shingle membrane layer may have a thickness of 30 to 110 mil. In some embodiments, when the shingle membrane layer comprises asphalt, the shingle membrane may have a thickness of 40 mil, 50 mil, 63 mil, 80 mil, 103 mil, 104 mil, 120 mil, or 130 mil. In some embodiments, when the shingle membrane layer comprises EPDM, the shingle membrane may have a thickness of 45 mil, 60 mil, or 80 mil. In some embodiments, when the shingle membrane layer comprises PVC, the shingle membrane may have a thickness of 45 mil, 60 mil, or 80 mil.

In some embodiments, the shingle membrane layer may have a weight of 426 GSM.

In some embodiments, with the embossed roofing shingle with a first TPO layer, a second butyl adhesive layer under the first layer, and a third shingle membrane layer under the second layer, may have a total thickness of 206 mils.

In some embodiments, the third layer may comprise a torchable membrane layer. In some embodiments, torchable membrane layer may be configured to be mechanically attached, by melting, to the roof deck.

In some embodiments, the torchable membrane layer may have a thickness of 114 mil.

In some embodiments, the shingle membrane layer may have a weight of 348 GSM.

In some embodiments, with the embossed roofing shingle with a first TPO layer, a second butyl adhesive layer under the first layer, and a third shingle membrane layer under the second layer, may have a total thickness of 216 mils.

In some embodiments, the present invention may include a roofing system, comprising: a roof deck; and an embossed roofing shingle located on the roof deck. In some embodiments, the embossed roofing shingle may comprise any of the embossed roofing shingles described herein.

In some embodiments, the present invention may provide a solar roofing system, comprising: a roof deck; at least one nailable photovoltaic shingle above the roof deck; and an embossed roofing shingle above the roof deck. In some embodiments, the embossed roofing shingle may comprise any of the embossed roofing shingles described herein. In some embodiments, the embossed roofing shingle may be located adjacent the nailable photovoltaic shingle on the roof deck

In some embodiments, the present invention may provide an embossed membrane. As used herein, an embossed membrane may be a component that is larger than a shingle; an embossed membrane may or may not be cut to provide shingles; and/or an embossed membrane may be configured to be disposed under another components, such as a shingle, after installation on the roof deck.

In some embodiments, the embossed membrane may comprise: a first layer, and a second layer under the first layer, wherein the first layer comprises an embossed surface, wherein the first layer comprises a thermoplastic polyolefin, wherein the first layer is configured to be exposed to the environment when the embossed roofing shingle is located on a roof deck, and wherein the second layer comprises a first adhesive.

In some embodiments, the first adhesive may comprise a butyl adhesive.

In some embodiments, the embossed membrane may further comprise a removable release liner under the second layer. In some embodiments, the removable release liner may be configured to be removed to expose the first adhesive.

In some embodiments, the embossed membrane may further comprise a scrim layer under the second layer. In some embodiments, the scrim layer may be configured to be mechanically attached to a roof deck. In some embodiments, the embossed membrane may further comprise a second adhesive layer under the scrim layer. In some embodiments, the embossed membrane may further comprise a removable release liner under the second adhesive layer, wherein the removable release liner is configured to be removed to expose the second adhesive layer.

In some embodiments, the embossed membrane may further comprise a fire-retardant layer under the second layer. In some embodiments, the fire-retardant layer may be configured to be mechanically attached to a roof deck. In some embodiments, the embossed membrane may further comprise a second adhesive layer under the fire-retardant layer. In some embodiments, the embossed membrane may further comprise a removable release liner under the second adhesive layer, wherein the removable release liner is configured to be removed to expose the second adhesive layer.

In some embodiments, the embossed membrane may further comprise a shingle membrane layer under the second layer. In some embodiments, the shingle membrane layer may be configured to be mechanically attached to a roof deck.

In some embodiments, the embossed membrane may further comprise a torchable membrane layer under the second layer. In some embodiments, the torchable membrane layer may be configured to be mechanically attached to a roof deck, by melting the torchable membrane layer.

In some embodiments of the invention, any of the disclosed embossed roofing shingles or embossed membranes may be manufactured by various processes.

In some embodiments, a roll of material of the first layer, such as but not limited to a TPO roll, may be embossed at an embossing station. Thus, the following references to a TPO roll may refer to any or all of the disclosed first layers, which are disposed in or on a roll. At the embossing station, any process that provides an embossed or textured top surface may be used. At an adhesive application station, the adhesive, such as the butyl adhesive, may be applied to the embossed TPO. At the adhesive application station, the release liner may be adhered to the TPO roll by the adhesive, or the fiberglass-reinforced fire-retardant layer may be adhered to the embossed TPO roll by the adhesive.

The method may further include, at a second adhesive application station, application of the second adhesive to the fiberglass-reinforced fire-retardant layer. The method may also include application of the release liner, at the second adhesive application station.

In some embodiments, the first layer may be extruded directly on to the third layer—for example, onto the scrim layer, the fire-retardant layer, the shingle membrane layer, and/or the torchable membrane layer. Thus, in some embodiments, the embossed membrane or embossed shingle may omit an adhesive layer underneath the first layer.

In some embodiments, instead of embossing a TPO roll, a TPO extrusion line may form the TPO sheet, and the TPO sheet may be subsequently embossed at the embossing station.

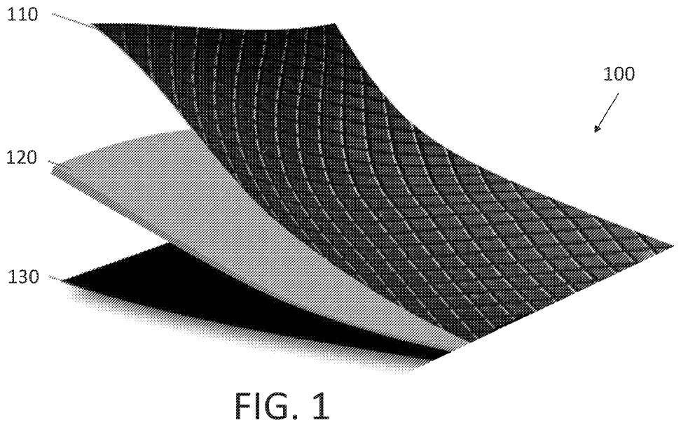

Turning to FIGS. 1-7, these figures show cross-sections of specific examples of different embodiments of the embossed roofing shingles and embossed roofing membranes, as described herein. In the figures, the layers are shown unattached. FIG. 1 shows an embossed roofing shingle 100, in accordance with the description herein. As shown, the embossed roofing shingle 100 may include a first layer 110, a second layer 120, and a third layer 130. The first layer 110 may be an embossed TPO (thermoplastic polyolefin) sheet. The second layer 120 may be an adhesive layer, such as a butyl adhesive. The third layer 130 may be a release liner, such as a removable silicone release liner, configured to be removed so that the embossed roofing shingle 100 may be adhered to a roof deck, such as either directly to the roof deck, or to an underlayment on the roof deck. Each of the components of embossed roofing shingle 100 may be as described herein.

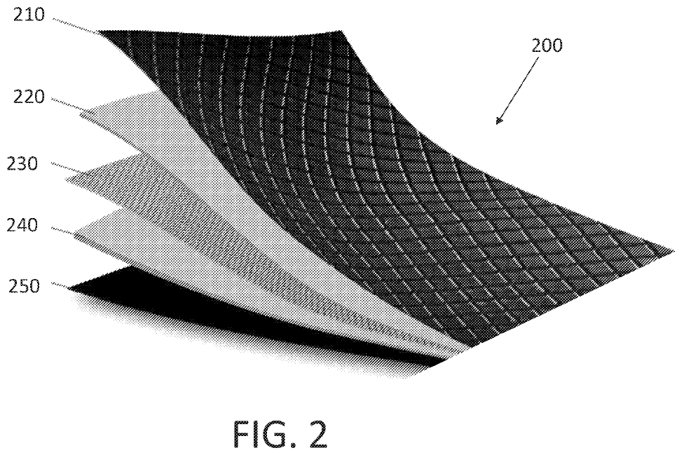

FIG. 2 shows an embossed roofing shingle 200, in accordance with the description herein. As shown, the embossed roofing shingle 200 may include a first layer 210, a second layer 220, a third layer 230, a fourth layer 240, and a fifth layer 250. The first layer 210 may be an embossed TPO (thermoplastic polyolefin) sheet. The second layer 220 may be an adhesive layer, such as a butyl adhesive.

The third layer 230 may be a scrim layer. In some embodiments, the scrim layer may be a fiberglass-reinforced scrim layer. The fourth layer 240 may be a second adhesive layer. In some embodiments, the second adhesive may be a butyl adhesive. The fifth layer 250 may be a release liner, such as a removable silicone release liner, configured to be removed so that the embossed roofing shingle 200 may be adhered to a roof deck, such as either directly to the roof deck, or to an underlayment on the roof deck. Each of the components of embossed roofing shingle 200 may be as described herein.

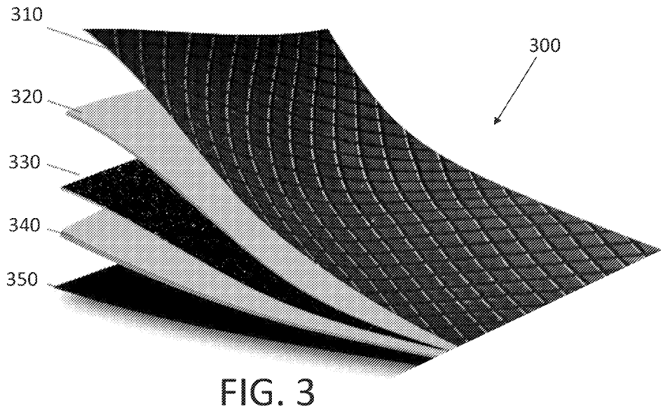

FIG. 3 shows an embossed roofing shingle 300, in accordance with the description herein. As shown, the embossed roofing shingle 300 may include a first layer 310, a second layer 320, a third layer 330, a fourth layer 340, and a fifth layer 350. The first layer 310 may be an embossed TPO (thermoplastic polyolefin) sheet. The second layer 320 may be an adhesive layer, such as a butyl adhesive.

The third layer 330 may be a fire-retardant layer. In some embodiments, the fire-retardant layer may be a fiberglass-reinforced fire-retardant layer. The fourth layer 340 may be a second adhesive layer. In some embodiments, the second adhesive may be a butyl adhesive. The fifth layer 350 may be a release liner, such as a removable silicone release liner, configured to be removed so that the embossed roofing shingle 300 may be adhered to a roof deck, such as either directly to the roof deck, or to an underlayment on the roof deck. Each of the components of embossed roofing shingle 300 may be as described herein.

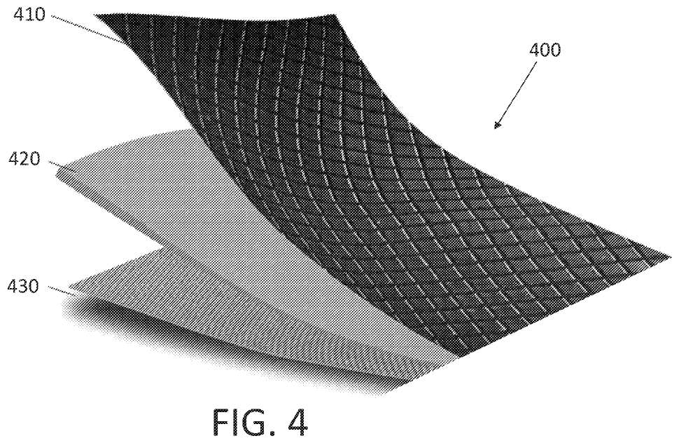

FIG. 4 shows an embossed roofing shingle 400, in accordance with the description herein. As shown, the embossed roofing shingle 400 may include a first layer 410, a second layer 420, and a third layer 430. The first layer 410 may be an embossed TPO (thermoplastic polyolefin) sheet. The second layer 420 may be an adhesive layer, such as a butyl adhesive.

The third layer 430 may be a scrim layer. In some embodiments, the scrim layer may be a fiberglass-reinforced scrim layer. In some embodiments, the third layer 430 may be configured to be mechanically attached to a roof deck, such as either directly to the roof deck, or to an underlayment on the roof deck. Each of the components of embossed roofing shingle 400 may be as described herein.

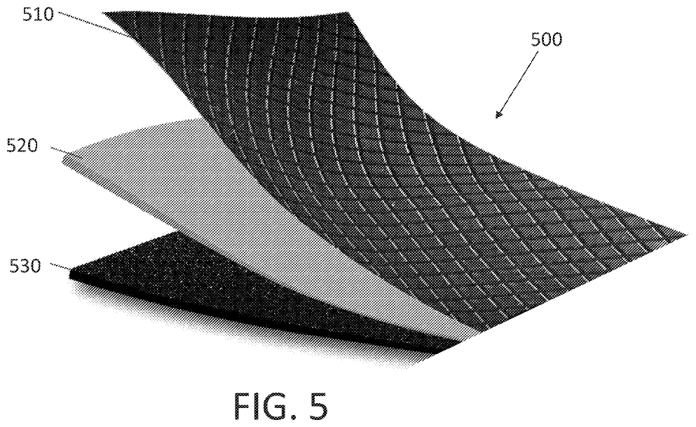

FIG. 5 shows an embossed roofing shingle 500, in accordance with the description herein. As shown, the embossed roofing shingle 500 may include a first layer 510, a second layer 520, and a third layer 530. The first layer 510 may be an embossed TPO (thermoplastic polyolefin) sheet. The second layer 520 may be an adhesive layer, such as a butyl adhesive.

The third layer 530 may be a fire-retardant layer. In some embodiments, the fire-retardant layer may be a fiberglass-reinforced fire-retardant layer. In some embodiments, the third layer 530 may be configured to be mechanically attached to a roof deck, such as either directly to the roof deck, or to an underlayment on the roof deck. Each of the components of embossed roofing shingle 500 may be as described herein.

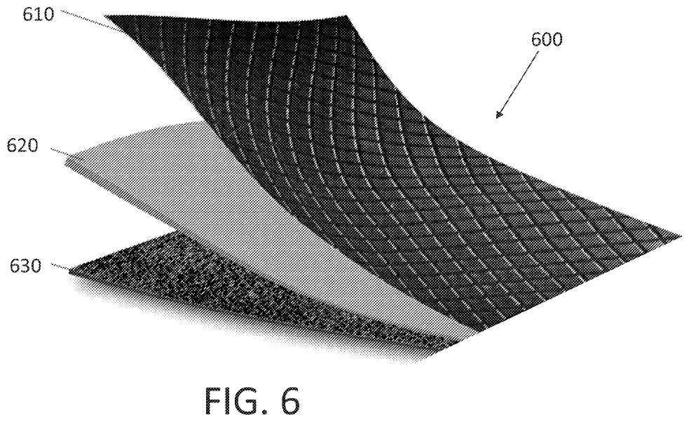

FIG. 6 shows an embossed roofing shingle 600, in accordance with the description herein. As shown, the embossed roofing shingle 600 may include a first layer 610, a second layer 620, and a third layer 630. The first layer 610 may be an embossed TPO (thermoplastic polyolefin) sheet. The second layer 620 may be an adhesive layer, such as a butyl adhesive.

The third layer 630 may be a shingle membrane layer. In some embodiments, the shingle membrane layer may be an asphalt shingle layer. In some embodiments, the third layer 630 may be configured to be mechanically attached to a roof deck, such as either directly to the roof deck, or to an underlayment on the roof deck. Each of the components of embossed roofing shingle 600 may be as described herein.

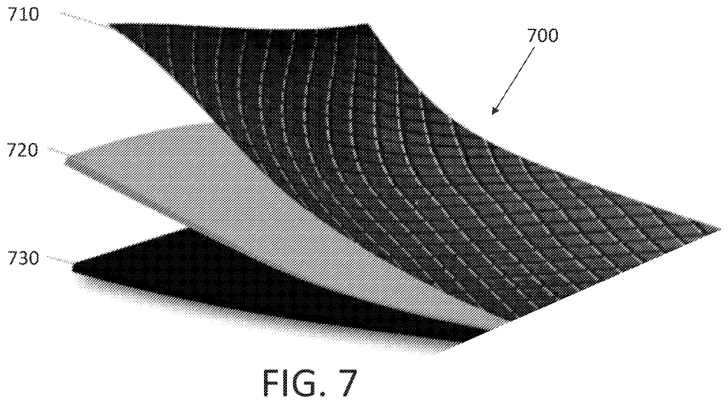

FIG. 7 shows an embossed roofing shingle 700, in accordance with the description herein. As shown, the embossed roofing shingle 700 may include a first layer 710, a second layer 720, and a third layer 730. The first layer 710 may be an embossed TPO (thermoplastic polyolefin) sheet. The second layer 720 may be an adhesive layer, such as a butyl adhesive.

The third layer 730 may be a torchable membrane layer. In some embodiments, the third layer 730 may be configured to be mechanically attached, by melting, to a roof deck, such as either directly to the roof deck, or to an underlayment on the roof deck. Each of the components of embossed roofing shingle 700 may be as described herein.

An embossed roofing membrane, and/or an embossed roofing shingle, may be in accordance with any of the above-described and shown embodiments.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive. By way of further example, any of the disclosed layers from any of the embodiments may be combined with one or more layers from one or more of any of the other embodiments, to provide an embossed roofing shingle or embossed roofing membrane.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A solar roofing system, comprising:
a roof deck;
at least one nailable photovoltaic shingle installed on the roof deck, the at least one nailable photovoltaic shingle comprising
at least one solar cell, and
a backsheet under the at least one solar cell,
wherein the backsheet is mechanically attached to the roof deck; and
a plurality of embossed roofing shingles installed on the roof deck adjacent to the at least one nailable photovoltaic shingle on the roof deck,
wherein the plurality of embossed roofing shingles comprising a first embossed roofing shingle,
wherein the first embossed roofing shingle comprises:
a first layer, and
a second layer under the first layer, wherein the first layer comprises an embossed surface, wherein the first layer comprises a thermoplastic polyolefin, and wherein the first layer is exposed to the environment.

2. The solar roofing system according to claim 1, wherein the second layer comprises an adhesive.

3. The solar roofing system according to claim 1, wherein the second layer comprises a butyl adhesive.

4. The solar roofing system of claim 1, wherein the second layer adheres the first embossed roofing shingle to the roof deck.

5. The solar roofing system of claim 1, wherein the first embossed roofing shingle further comprises:
a third layer under the second layer,
wherein the third layer comprises a scrim layer.

6. The solar roofing system of claim 5, wherein the scrim layer comprises fiberglass.

7. The solar roofing system of claim 5, wherein the scrim layer comprises a fiberglass-reinforced scrim layer.

8. The solar roofing system of claim 1, wherein the first embossed roofing shingle further comprises:
a third layer under the second layer,
wherein the third layer comprises a fire-retardant layer.

9. The solar roofing system of claim 1, wherein the first embossed roofing shingle further comprises:
a third layer under the second layer,
wherein the third layer comprises a shingle membrane layer.

10. The solar roofing system of claim 1, further comprising:
a plurality of fasteners,
wherein the plurality of fasteners comprises at least a first fastener and a second fastener,
wherein the first fastener penetrates the roof deck and the at least one nailable photovoltaic shingle,
wherein the second fastener penetrates the first embossed roofing shingle.

11. The solar roofing system of claim 1, wherein the first embossed roofing shingle further comprises:
a third layer under the second layer,
wherein the third layer comprises a torchable membrane layer melted to the roof deck.

12. The solar roofing system of claim 1, further comprising:
a plurality of fasteners,
wherein the plurality of fasteners comprises at least a first fastener and a second fastener,
wherein the first fastener penetrates the roof deck and the at least one nailable photovoltaic shingle,
wherein the second fastener penetrates the first embossed roofing shingle.

13. A solar roofing system, comprising:
a roof deck;
at least one nailable photovoltaic shingle installed on the roof deck, the at least one nailable photovoltaic shingle comprising
at least one solar cell, and
a backsheet under the at least one solar cell,
wherein the backsheet is mechanically attached to the roof deck; and
at least one non-photovoltaic shingle installed on the roof deck adjacent to the at least one nailable photovoltaic shingle on the roof deck; and
an embossed membrane installed between the roof deck and at least one of the at least one nailable photovoltaic shingle and the at least one non-photovoltaic shingle,
wherein the embossed membrane comprises:
a first layer, and
a second layer under the first layer,
wherein the first layer comprises an embossed surface,
wherein the first layer comprises a thermoplastic polyolefin, and
wherein the second layer is between the first layer and the roof deck.

14. The solar roofing system of claim 13, wherein the second layer comprises an adhesive.

15. The solar roofing system of claim 13, wherein the second layer comprises a butyl adhesive.

16. The solar roofing system of claim 13, wherein the second layer adheres the embossed membrane to the roof deck.

17. The solar roofing system of claim 13, wherein the embossed membrane further comprises:
a third layer under the second layer,
wherein the third layer comprises a scrim layer.

18. The solar roofing system of claim 17, wherein the scrim layer comprises fiberglass.

19. The solar roofing system of claim 13, wherein the embossed membrane further comprises:
a third layer under the second layer,
wherein the third layer comprises a fire-retardant layer.

20. The solar roofing system of claim 13, wherein the embossed membrane further comprises:
a third layer under the second layer,
wherein the third layer comprises a shingle membrane layer.
